(19) United States
(12) Patent Application Publication
(10) Pub. No.: US 2022/0267543 A1
(43) Pub. Date: Aug. 25, 2022

(54) PREPREG OR SEMIPREG PRECURSOR AND METHOD OF MANUFACTURING SAME

(71) Applicant: HEXCEL COMPOSITES LIMITED, Duxford (GB)

(72) Inventors: Mark WHITER, Saffron Walden (GB); Ben TIPLER, Withersfield (GB); Mathilde MAILLOT, Duxford (GB)

(73) Assignee: HEXCEL COMPOSITES LIMITED, Duxford, Cambridgeshire (GB)

(21) Appl. No.: 17/625,157

(22) PCT Filed: Jul. 19, 2020
(86) PCT No.: PCT/EP2020/070388

§ 371 Date: Jan. 6, 2022

(30) Foreign Application Priority Data
Jul. 19, 2019 (GB) 1910407.4

(51) Int. Cl. C08J 5/24; C08K 3/40

(52) U.S. Cl. CPC C08J 5/244; C08K 3/40; C08J 2363/00

(57) ABSTRACT

A prepreg or semipreg precursor comprising a fibre reinforcement and a resin composition fused thereto, the resin composition containing at least one epoxy resin and a latent curing agent, wherein the epoxy resin and the latent curing agent form a solid phase at ambient temperature, the latent curing agent forming a discrete phase within the epoxy resin. The stabilized uncured resin composition and prepregs and semipregs incorporating the same are easy to handle, have desirable curing temperatures and show good outlife at ambient to mid range temperatures.

The present invention relates to a prepreg or semipreg precursor, a method of manufacturing a prepreg or semipreg precursor, and a prepreg or semipreg precursor obtainable by such a method. The present invention is particularly concerned with the preparation of prepregs and semipreg precursors made from epoxy resins, which are easy to handle, have low curing temperatures and long out-life (latency) at ambient temperatures, as well as a method of manufacturing the same that lends itself readily to automation and requires fewer process steps.

Prepreg is the term used to describe fibres and/or fabric impregnated with a resin in the uncured state and ready for curing by the application of heat and/or pressure. The fibres may be in the form of tows or fabrics. The tows or fabrics generally comprise a plurality of thin fibres called filaments. The fibrous material may be in the form of multiple fibre tows each containing multiple fibre filaments to form each tow. The tows may be stitched or woven to form a fabric. The selection of fibrous materials and resins employed in the prepregs depends upon the properties required of the cured composite material and also the use to which the composite is to be put. Semipreg is the term often used to describe fibres and/or fabric that has been only partially impregnated so that the resin is bonded to the surface of the fibres but not so that the fibres are wet out, i.e. the resin is on the surface of the fibres and not fully dispersed throughout the reinforcement.

Various methods have been proposed for the production of prepregs, one of the preferred methods being the impregnation of a moving fibrous web with a liquid, molten or semi-solid uncured thermosetting resin. The prepreg produced by this method is then cut into sections of desired dimensions and a stack of the sections is moulded and cured by heating to produce the final fibre reinforced laminate. Curing may be performed in an autoclave or in a vacuum bag which may be placed in a mould for curing. Alternatively, the stack may be formed in a closed mould and cured directly in the mould by heating (compression moulding), such as in the press moulding of laminates for automotive body structural parts. Following formation of the laminate, it may be cut to the required shape.

Conventional prepregs are generally supplied by specialist manufacturers in the form of thin layers of fibre or fabric impregnated with resin and sandwiched between layers of protective paper or polyethylene film. The prepregs can be separated from the layers of paper or film and placed into a mould or vacuum bag for curing at elevated temperature at their intended site of use. Such prepregs are formed from “single component” resin compositions which already contain curatives and/or hardeners necessary to cure the composition at elevated temperature and, as the resin components are usually in highly viscous liquid or semi-solid state, interaction between the curative and the resin components means that the resin compositions can start to cure, even at ambient temperature. This problem has been further compounded by the commercial desire for prepregs made from resin compositions that can cure at relatively low temperatures, typically 100° C. or less, in order to minimize the industrial conditions required to achieve cure, such as curing time or pressure, which can increase processing costs. Consequently, such prepregs must usually be stored refrigerated or frozen, for example, at −18° C. Once the prepregs are taken out of a freezer in preparation for use, they begin to cure at ambient temperature and must generally be used within a short period of time, before any significant degree of low temperature cure has occurred that may adversely affect the desired properties of the resultant composite material after curing at elevated temperature. The length of time that such prepregs can remain viable after being taken out of the freezer and stored at ambient temperature is usually referred to as the out-life or latency period of the prepreg. Various attempts have been made at improving out-life or latency of single component resin matrices for prepregs.

One approach to dealing with the problem of short outlife is to provide the resins and curing agents as separate components for mixing shortly before laying up of fibrous materials. For example, dry fibrous layers may be laid down and separate resin and curing components may be mixed and then applied to the fibres. However, this additional processing time adds costs, and also requires very accurate mixing. Similarly, fibrous layers and resins may be combined before or after laying down, and powdered curing agents may then be applied to the surface of the resin coated fibres. However, this also requires additional processing steps and it can be very difficult to achieve accurate application/mixing of curing agents and resin. Both these procedures also suffer from the disadvantage of requiring the handling of dry/powdered curing agents which can be dangerous/toxic and may require special conditions and/or safety equipment.

Epoxy resins have a wide range of applications, such as, for example, in paints, in metal coatings, in electrical components as high tension electrical insulators or for encapsulating LEDs, in the civil construction industry, in fibre-reinforced plastic materials, and as adhesives, especially adhesives for use in the structural bonding of metals and composites in the aerospace, industrial and automotive industries. Epoxy resins are particularly versatile in such applications because of the wide range of combinations of epoxy resin components and curatives which can participate in cross-linking of linear, short-chain epoxy resin precursor components to form large, three-dimensional cross-linked structures of cured epoxy resin. Such compositions can also include a wide range of additives to modify the properties of the cured epoxy resin, such as fillers, plasticizers, hardeners and tougheners, or to modify the rate at which the resins cure, such as accelerators.

The use of epoxy resins in fibre or fabric reinforced composites is well-known. Composites comprising fibre reinforcement materials and, in particular, prepregs comprising fibres or fabrics and epoxy resins, may be stacked or shaped to form preforms. These stacks or preforms are subsequently cured, for example in an autoclave, a mould and/or a vacuum bag to form a reinforced composite material. Such composite materials are lightweight and of high strength and are used in many structural applications, such as in the automotive and aerospace industries, as well as in many other industrial applications, including wind turbines.

EP 1802701, for example, discloses an uncured assembly which comprises a fibrous reinforcement having associated therewith a resin material comprising at least one solid amine-terminated epoxy resin, at least one solid epoxy-terminated epoxy resin and, optionally, at least one cure catalyst. This document discloses that such assemblies can be cured at 90° C. and have been stored for up to 4 weeks at ambient temperature without any detriment to performance. EP 1802701 discloses that such results are achieved by the preparation and use of a solid amine-terminated epoxy resin instead of traditional curing agents, such as aliphatic amine curing agents, which are invariably mobile liquids at room temperature and tend to react with carbon dioxide in the atmosphere leading to carbamation and subsequent deactivation, or imidazoles, which are insufficiently active.

EP 3081368 discloses a method of producing a fibre-plastic composite semi-finished product using a fibre reinforcement material mixed with a one-component plastic system, wherein the composite semi-finished product can be stored under normal conditions and shaped like a thermoplastic system, but has thermosetting properties after curing. This document discloses that the one-component plastic system preferably comprises an epoxy resin based on bisphenol A and a modified amine as a latent hardener, preferably a secondary amine such as imidazole or an imidazole derivative. The specific examples in EP 3081368 disclose continuous methods of preparing a composite-semi finished product on a conveyor belt system using a powder resin system, such as, for example, one based on the reaction product of 4,4′-diisopropylidenediphenol with 1-chloro-2,3-epoxypropane. However, no further details of the resin system or curing agent, or the properties of the composite semi-finished product obtained by such methods are disclosed.

The various approaches to making prepregs or prepreg precursors comprising a fibre reinforcement material and an epoxy resin matrix described above suffer from certain disadvantages, such as the use of curing agents that are only active at elevated cure temperatures or require additional preparation steps or are prone to degradation over relatively short periods unless stored at low temperatures.

The present invention aims to obviate, or at least mitigate, all or at least some of the aforesaid problems and/or to provide improvements generally.

According to the present invention, there is provided a prepreg or semipreg precursor, a method of manufacturing a prepreg or semipreg precursor and a prepreg or semipreg precursor obtainable by such a method as described hereinafter or as defined in any one of the accompanying claims.

Accordingly, in a first aspect of the invention, there is provided a prepreg or semipreg precursor comprising a fibre reinforcement and a resin composition fused thereto, the resin composition containing at least one epoxy resin and a latent curing agent, wherein the epoxy resin and the latent curing agent form a solid phase at ambient temperature, the latent curing agent forming a discrete phase within the epoxy resin.

In a further aspect of the invention, there is provided a method of manufacturing a prepreg or semipreg precursor, which comprises the steps of:

(a) preparing a resin composition mixture containing finely divided particles of at least one epoxy resin and finely divided particles of a latent curing agent, wherein the epoxy resin and the latent curing agent are both in the solid phase at ambient temperature;

(b) applying a layer of the resin composition mixture to a first layer of fibre reinforcement and, optionally, applying a second layer of fibre reinforcement thereto;

(c) sintering the lamellar structure of step (b) so as to fuse the resin composition to the fibre reinforcement layer or layers and so that the latent curing agent forms a discrete phase within the sintered epoxy resin; and

(d) optionally cooling the resultant prepreg or semipreg precursor.

In a yet further aspect of the invention, there is provided a prepreg or semipreg precursor obtainable by a method according to the present invention.

Ambient temperature generally means the temperature of the immediate surroundings in which materials are being handled or stored. In the present case, ambient temperature may be considered to be equivalent to 23° C.

In the prepreg and semipreg precursors of the present invention, the epoxy resin and the latent curing agent of the resin composition form a solid phase at ambient temperature with the latent curing agent forming a discrete phase within the epoxy resin. This means that at ambient temperature the epoxy resin is in the form of a solid or porous mass, with the latent curing agent distributed in discrete particles or domains throughout the mass. This structure may be achieved by mixing finely divided particles of the epoxy resin component with finely divided particles of the latent curing agent component, applying this mixture to a layer of fibre reinforcement, optionally applying a second layer of fibre reinforcement to the mixture, and causing the epoxy resin to sinter so that the latent curing agent forms a discrete phase within the sintered resin. Sintering is a process in which a particulate or granular material coalesces into a solid or porous mass without liquefaction. Sintering may be achieved by applying heat and/or pressure to the particulate or granular material. In the prepreg or semipreg precursors of the present invention, once the solid phase has been formed it remains relatively stable at ambient conditions, i.e. it remains as a sintered solid, for example it does not spontaneously revert to a powder form or liquefy.

As noted herein, when the solid phase is first formed by sintering, the latent curing agent forms a discrete phase within the epoxy resin. In certain cases, this discrete phase may gradually become less discernible over prolonged storage as the degree of sintering in the epoxy increases over time. However, it is the initial creation of a solid phase in which the latent curing agent forms a discrete phase within the epoxy resin that is critical to enhanced outlife associated with the prepreg and semipreg precursors of the present invention, and it is considered that all materials created with this initial form are within the scope of the present invention.

As the resin composition is sintered in contact with the layer or layers of fibre reinforcement it will generally be stably attached to the fibre reinforcement at ambient temperature in the prepreg and semipreg precursors of the present invention.

In embodiments of the prepreg and semipreg precursors of the present invention the resin composition may be present as a layer on the surface of the fibre reinforcement or sandwiched between two layers of fibre reinforcement without penetrating the fibres to any great degree. In alternative embodiments, the resin may be more closely integrated with the fibres, for example by forcing the powdered resin composition into the surface of the fibre reinforcement before sintering, for example by vibration. However, the prepreg and semipreg precursors of the invention are distinguished from conventional prepregs and semipregs because the resin component is in the solid phase as a sintered mass. During curing of the prepreg and semipreg precursors of the invention the resin impregnates or wets out the fibres before fully curing in the same manner as in conventional prepregs and semipregs.

Prepreg and semipreg precursors according to the present invention have excellent outlife at ambient, and even at elevated, temperatures because, as the resin and curing agent components are in solid form the interaction therebetween is significantly reduced before active curing is carried out.

The fibre reinforcement comprises a fibrous material which may be in the form of fibres or fibre tows, which are preferably used in the form of a sheet or continuous mat or continuous filaments of fibre. In other embodiments, the fibre reinforcement may comprise a natural fibre or staple fibre of short length. The fibrous material may be in the form of multiple fibre tows each containing multiple fibre filaments to form each tow. The tows may be stitched or woven to form a fabric or be in the form of a non-woven fabric.

The fibres may consist of natural materials, such as cotton, flax, hemp, wool, silk, etc.; semi-synthetic materials, such as rayon, viscose, modal, etc.; or synthetic materials, such as carbon, polyester, nylon, acrylic, glass or mineral, etc. In preferred embodiments, the fibre reinforcement comprises carbon fibres or glass fibres.

In an embodiment, the fibre reinforcement is in the form of non-woven fibrous material such as a veil or a discontinuous fibre fleece. Suitable glass and carbon or metal-coated carbon veils are commercially available under the trade name Optiveil® from Technical Fibre Products Limited, Burnside Mills, Kendal, Cumbria, United Kingdom.

In preferred embodiments of the present invention the fibre reinforcement is in the form of a fabric.

In one embodiment, the fibre reinforcement is in the form of a woven fabric. In this embodiment, the warp and weft of the fabric may be formed from fibre tows or fibre filaments.

In another embodiment, the fibre reinforcement is in the form of a non-woven fabric or mat. Non-woven fabrics include fabrics in which a non-structural stitching thread, such as a polyester yarn, is used to bind together two or more layers of fibre tows to avoid misalignment, instead of using a conventional weaving process. The fibre tows or filaments in adjacent layers may be in a different spatial orientation relative to one another, such as, for example, a fabric consisting of two layers of unidirectional fibre tows in which the fibre tows in the first layer are at an angle of −45° and the fibre tows in the second layer are at an angle of +45°, relative to a forward axis in the two dimensional plane containing both layers. Such non-woven fabrics may be biaxial or multiaxial depending upon the number of layers of fibre tows at different angles to one another. The use of stitching instead of weaving to hold the layers of fibre tows together is known to improve drapability of the resultant non-woven fabric, thereby reducing the tendency of the fabric and prepreg formed therefrom to crimp, i.e., to form furrows or ridges, when laid up in a mould. Consequently, engineered fabrics of this type are often referred to as non-crimp fabrics (NCF). The fibre reinforcement may also comprise layers of unidirectional fibre tows.

In an embodiment, the fabric is a multi-axial non-woven or non-crimped fabric. In a further embodiment, the fabric is a multiaxial non-crimped fabric that is assembled in situ and held together by the fused resin composition, preferably wherein the fabric in the prepreg or semipreg precursor is stitch-free.

Suitable woven and non-woven fabrics for use in composites are commercially available from a number of specialist manufacturers including Chomarat Textiles Industries, Esher, Surrey, United Kingdom, Hexcel Reinforcements UK Limited, Narborough, Leicestershire, United Kingdom, and Zhenshi Group Hengshi Fibreglass Fabrics Co., Ltd., Tongxiang Economic Development Zone, Jiaxing Zhejiang, 314500 China. In an embodiment, the fabric is a carbon fibre or glass fibre biaxial non-woven fabric, such as BB200, BB600 or BB1200.

Hybrid or mixed fibre systems may also be envisaged. The use of cracked (i.e. stretch-broken) or selectively discontinuous fibres may be advantageous to facilitate lay-up of the product according to the invention and improve its capability of being shaped.

The surface mass of fibres within the fibre reinforcement is generally in the range of 80-4000 g/m². In embodiments, the surface mass of fibres is in the range of 100 to 2500 g/m², 150 to 2000 g/m², 150 to 1200 g/m², 200 to 1200 g/m², 200 to 600 g/m² or 200 to 400 g/m², or any combination thereof. The number of carbon filaments can vary from 3000 to 320,000, again preferably from 6,000 to 24,000. For fibreglass reinforcements, fibres of 600-2400 tex are particularly adapted.

The fibres may be utilised in unidirectional form, or as non-woven mats, woven fabrics, multi-axial fabrics or non-crimped fabrics. Combinations of those reinforcement forms may also be utilized.

In an embodiment of the invention the resin composition is distributed on a surface of the fibre reinforcement, alternatively or additionally the resin composition may be distributed throughout the fibre reinforcement.

In a preferred embodiment of the invention, the prepreg or semipreg precursor of the invention comprises two layers of fibre reinforcement fused together by the resin composition.

The epoxy resin component of the resin composition of the prepreg or semipreg precursors of the present invention is generally a solid at ambient temperature prior to formation of the resin composition. The resin composition may comprise a blend of two or more epoxy resins, and in this case, it is not essential that all of the epoxy resins are solid at ambient temperature. In an embodiment, the resin composition comprises a mixture of at least one solid epoxy resin and at least one semi-solid epoxy resin. The semi-solid epoxy resin(s) may be present in an amount such that the resultant epoxy resin mixture remains a solid at ambient temperature. In further embodiments, the semi-solid epoxy resin(s) are present in an amount of 1 to 50% by weight, 1 to 40% by weight, 1 to 30% by weight, 1 to 20% by weight, or 1 to 10% by weight, based on the total weight of the mixture of epoxy resins.

The epoxy resin component of the resin composition may comprise an aromatic epoxy resin. Aromatic epoxy resins as referred to herein are epoxy resins containing at least one aromatic unit in the backbone or in a side chain, if present. Typically, the aromatic epoxy resins include at least one aromatic epoxide moiety, such as, for example, a glycidyl ether, preferably at a terminal position of the resin backbone or side chain, if present. Aromatic epoxy resins that can be used include, for example, the reaction product of phenols (phenols and formaldehyde) and epichlorohydrin, peracid epoxies, glycidyl esters, glycidyl ethers, the reaction product of epichlorohydrin and amino phenols, the reaction product of epichlorohydrin and glyoxal tetraphenol, and the like. Phenols as referred to above include polynuclear phenols (i.e. compounds having at least two phenol functional groups). Typical examples of polynuclear phenols are bisphenols.

The aromatic epoxy resin component of the resin composition can be in solid or semi-solid form or a blend thereof. The aromatic epoxy resin or blend thereof will generally be a solid prior to formation of the resin composition, such that it can be ground or finely divided into particulate or powder form in the manner described hereinafter, Suitable epoxy resins may comprise blends of two or more epoxy resins selected from monofunctional, difunctional, trifunctional, and/or tetrafunctional epoxy resins. Suitable difunctional epoxy resins, for example, include those based on: bisphenol F, bisphenol A (optionally brominated), phenol, aromatic glycidyl amines, naphthalene, or any combination thereof.

In preferred embodiments of the invention, the at least one epoxy resin of the resin composition comprises a difunctional epoxy resin or a blend of difunctional epoxy resins. In particularly preferred embodiments, the at least one epoxy resin is a bisphenol A or bisphenol F based epoxy resin.

In an embodiment, the epoxy resin or epoxy resin blend used in the resin composition has a melting or softening temperature below about 100° C. In other embodiments, the epoxy resin or epoxy resin blend has a softening temperature in the range of 60 to 100° C., 65 to 100° C., 70 to 100° C., 75 to 95° C., or 80 to 90° C., or any combination thereof. In another embodiment, the epoxy resin or epoxy resin blend has an uncured glass transition temperature, Tg, of no more than 50° C. In further embodiments, the epoxy resin or epoxy resin blend has an uncured Tg in the range of 25 to 50° C., 30 to 45° C., 35 to 40° C. or any combination thereof.

In an embodiment, the epoxy resin or epoxy resin blend used in the resin composition has an epoxy equivalent weight of at least 300 grams/equivalent (g/eq.). In further embodiments, the epoxy resin or epoxy resin blend has an epoxy equivalent weight in the range of 300 to 3000 g/eq., 350 to 2500 g/eq., 400 to 2000 g/eq., 450 to 1500 g/eq., or any combination thereof.

In an embodiment, the epoxy resin or epoxy resin blend used in the resin composition has a viscosity of 100 to 10000 mPa·S at 25° C. as measured as a 40% solution in butylcarbitol. In further embodiments, the epoxy resin or epoxy resin blend has a viscosity in the range of 110 to 5000 mPa·S, 120 to 2500 mPa·S, 130 to 2000 mPa·S, 140 to 1500 mPa·S, 150 to 1000 mPa·S, 150 to 500 mPa·S, 150 to 250 mPa·S, or any combination thereof.

Suitable solid or semi-solid aromatic epoxy resins are commercially available from Huntsman Advanced Materials (Switzerland) S. A., Monthey, Switzerland, under the tradename Araldite®. Suitable high molecular weight basic solid epoxy resins include Araldite® GT 6097, Araldite® GT 6099, Araldite® GT 6609, Araldite® GT 6610, Araldite® GT 6810-1, Araldite® GT 7077 and Araldite® GT 16099. Suitable medium to low weight basic solid epoxy resins include Araldite® GT 6063, Araldite® GT 6064, Araldite® GT 6071, Araldite® GT 6084-2, Araldite® GT 6703, Araldite® GT 7004, Araldite® GT 7071 and Araldite® GT 7072. Suitable semi-solid basic epoxy resins include Araldite® GY 280 and Araldite® LY1589, which are both available from Huntsman Advanced Materials, and Epokukdo YD-134 and Epokukdo YD-136, which are commercially available from Kukdo Chemical Company Limited, Seoul, South Korea. However, the aromatic epoxy resin is not limited to the foregoing and includes other solid and semi-solid basic epoxy resins commonly used in epoxy adhesives and commercially available from a number of manufacturers and suppliers.

The resin composition used in the present invention also contains a latent curing agent. In the context of the present invention, the term “latent” curing agent refers to a compound that is capable of cross-linking the epoxy resin or epoxy resins in the composition under normal curing conditions, but does not interact significantly with the epoxy resin(s) at ambient temperature. The resin composition of the present invention is normally cured by heating the prepreg or semipreg precursor to a temperature of no more than 100° C., with additional application of pressure being optional. In an embodiment, the resin composition is cured by heating the prepreg or semipreg precursor to a temperature of 100° C. for a period of around 240 minutes. In another embodiment, the resin composition is cured by heating the prepreg or semipreg precursor to a temperature of 80° C. for a period of around 360 minutes. The specific time and conditions required to achieve curing of different epoxy resin compositions may be determined empirically in accordance with standard procedures (see, for example, Handbook of Epoxy Resins, First Edition, Henry Lee & Kris Neville, McGraw-Hill, New York, N.Y., USA, 1967; or Epoxy Resins, Curing Agents, Compounds, and Modifiers—An Industrial Guide, Second Edition, Ernest W. Flick, Noyes Publications, Park Ridge, N.J., USA, 1993).

The latent curing agent will typically have a high melting point well above the temperature at which the resin composition is cured. In embodiments, the latent curing agent will have a melting point of at least 150° C., preferably in a range of 150 to 250° C., 160 to 240° C., 170 to 230° C., 180 to 220° C., or any combination thereof. In an embodiment, the epoxy resin or epoxy resin blend has a softening temperature of no more than 100° C., so that when the resin starts to soften, the latent curing agent dissolves and interacts with the epoxy resin thereby effecting hardening or cross-linking of the resin. At temperatures below the softening point of the epoxy resin(s), the latent curing agent is insoluble and forms a separate phase within the epoxy resin(s).

Any suitable latent curing agent may be used in the resin composition, subject to the requirements that it should be a solid at ambient temperature.

In a preferred embodiment, the resin composition used in the present invention is free of amine or latent amine components. In the context of the present invention, the term “amine component” refers to a compound that contains a primary, secondary or tertiary amine group having a reactive lone pair of electrons on the nitrogen atom. Similarly, the term “latent amine component” refers to a compound that is capable of generating an amine compound, such as, for example, dicyandiamide (DICY), which is a dimer of cyanamide and which generates H₂N—CN upon heating, or a quaternary ammonium salt. Organic compounds containing primary, secondary or tertiary amine groups or latent amine groups are widely used as curing agents in single component epoxy resin formulations, often in conjunction with an accelerator or hardening agent. Such amine components can have a significant effect on the stability of single component epoxy resin systems and can reduce outlife. Although other curing agents that do not contain amine or latent amine groups are available, such as, for example, imidazoles or phenol, catechol and resorcinol derivatives, their use is often undesirable if low cure temperatures of no more than 100° C. are required. In a particular embodiment of the invention, the latent curing agent is the sole curing agent in the resin composition.

In an embodiment of the present invention, the latent curing agent includes at least one amide group. In this embodiment, the latent curing agent may be a substituted urea, sometimes referred to as a substituted urea accelerator. Suitable substituted urea accelerators include the range of materials available under the tradename Dyhard® from AlzChem Group AG, Trostberg, Germany, including UR200, UR300, UR400, UR500, UR600 and UR700, and the range of materials available under the tradename Omicure® from Emerald Performance Materials, Moorefield, N.J., USA, including U-24M, U-35M, U-52, U-52M, U-210, U-210M, U-405, U-405M, U-410M and U-415M.

In embodiments of the present invention, the latent curing agent may be present in an amount of 1 to 20% by weight based on the total weight of the resin composition. In embodiments, the latent curing agent is present in an amount of 1 to 15% by weight, 1 to 10% by weight, 1 to 9% by weight, 1 to 8% by weight, 1 to 7% by weight, 1 to 6% by weight, 1 to 5% by weight, 1 to 4% by weight, 1 to 3% by weight or 1 to 2% by weight based on the total weight of resin composition, or any combination thereof.

We have found that use of latent curing agents even in the absence of amine or latent amine components, or other traditional curing agents, in solid epoxy resin compositions can provide good curing at low temperatures, i.e., not more than about 100° C. Moreover, the ability to isolate a solid phase latent curing agent within a solid phase resin composition fused to a fibre reinforcement can provide a prepreg or semipreg precursor that has excellent handling properties, without problems associated with resins in liquid or powder form, and can significantly increase outlife of such precursors at ambient temperatures and even at storage temperatures as high as 45° C. or 55° C. These and other benefits of the present invention are dependent upon the ability to sinter the epoxy resin composition and cause it to fuse to the fibre reinforcement in the manner described in detail hereinafter. Whilst the resin composition is fused to the fibre reinforcement and can remain stably attached thereto, it is not essential for the fibre reinforcement to be completely impregnated with the resin composition at this stage. The prepreg or semipreg precursor may be subjected to further processing steps, such as, for example, re-heating the precursor to the uncured glass transition temperature of the epoxy resin once the precursor has been laid up in mould, so as to allow complete impregnation of the prepreg or semipreg, prior to final curing.

The finely divided particles of epoxy resin may be prepared by comminution or micronization of the epoxy resin by any suitable technique, such as crushing, grinding, cutting, vibrating, sonication, spray drying, or the like. In an embodiment, the finely divided particles of an epoxy resin or a blend of epoxy resins are ground using a mechanical grinder. Suitable mechanical grinders, including jaw crushers, rotor mills, cutting mills, knife mills, mortar grinders, disc mills and ball mills, are commercially available from a number of manufacturers, including Retsch GmbH, Haan, Germany. The finely divided particles of epoxy resin may be in the form of a powder. The epoxy resin may be a low melting point solid in which case, comminution or micronization of the epoxy resin may be carried out under cooling to prevent the epoxy resin from softening or melting. In an embodiment, the epoxy resin is converted into finely divided particles by mechanical or manual grinding, in the presence of an added cooling agent, such as dry ice.

Similarly, the finely divided particles of the latent curing agent may be prepared by comminution or micronization of the epoxy resin by any suitable technique, such as crushing, grinding, cutting, vibrating, sonication, spray drying, or similar processes. In an embodiment, the finely divided particles of the latent curing agent are ground using a mechanical grinder. The finely divided particles of latent curing agent may be in the form of a powder. Suitable latent curing agents as previously described in relation to the first aspect of the present invention include those commercially available from a number of suppliers, some grades of which are available in micronized form, such as, for example, Dyhard® UR500, and M-grades of Omicure®, including U-24M, U-35M, U-52M, U-210M, U-405M, U-410M and U-415M.

The finely divided particles of epoxy resin and the finely divided particles of latent curing agent may be mixed using any suitable mixing techniques and apparatus, including mechanical mixers or stirrers. On a laboratory scale, the finely divided particles of epoxy resin and the finely divided particles of latent curing agent may be mixed together by hand, for example, in a suitable container using a tumbling and shaking motion. In an embodiment, the epoxy resin and the latent curing agent are in powder form. Such powder forms of epoxy resin and latent curing agent may be sufficiently free flowing to allow mixing and subsequent application of the resultant mixture to the fibre reinforcement. However, a flow aid or anti-caking agent may also be added at this stage, in order to facilitate subsequent application of the resultant resin composition mixture to the fibre reinforcement. Any suitable flow aid or anti-caking agent may be used, including stearic acid, calcium stearate, magnesium stearate, sodium silicate, silica (silicon dioxide), tricalcium phosphate, powdered cellulose, sodium bicarbonate, sodium silicate, calcium silicate, magnesium trisilicate, sodium aluminosilicate, calcium aluminosilicate, potassium aluminium silicate, aluminium silicate, polydimethylsiloxane, bentonite, talcum powder, sodium ferrocyanide, potassium ferrocyanide, calcium ferrocyanide, calcium phosphate, and acrylic resins and acrylates. Suitable acrylic resin based flow aids are commercially available under the tradename Modaflow® manufactured by Allnex Management GmbH, Frankfurt am Main, Germany, including Modaflow® Resin, Modaflow® Powder III, Modaflow® Powder 6000, Modaflow® Lambda, Modaflow® Epsilon, Modaflow® 2100, Modaflow® 9200, and Modaflow® AQ 3025.Suitable hydrophobic fumed silica based flow aids are commercially available under the tradename Aerosil® from Evonik Resource Efficiency GmbH, Essen, Germany, including R 972, R 974, R 104, R 106, R 202, R 208, R 205, R 805, R 812, R 812 S, R 816, R 7200, R 8200, R 9200, R 711, RY 50, NY 50, NY 50 L, RY 200, RY 200 S, RX 50, NAX 50, RX 200, RX 300, R 504, NX 90 S, NX 90 G, RY 300, REA 90, REA 200, RY 51, NA 50 Y, RA 200 HS, NA 50 H, RA 200 H, NA 130 K, NA 130, RY 200 L, R 709 and R 976 S. If present, the flow aid or anti-caking agent may be present in an amount of 0.01 to 5% by weight based on the total weight of the resin composition or 0.1 to 2%, 0.1 to 1% by weight, 0.2 to 0.8% by weight, or 0.3 to 0.5% by weight based on the total weight of the resin composition, or any combination thereof.

The finely divided particles of epoxy resin and/or finely divided particles of latent curing agent may be passed through one or more sieves in order to achieve a uniform or selected particle size distribution. Suitable sieves and sieving equipment are widely commercially available from a number of manufacturers. In an embodiment, the epoxy resin is ground on a Retsch® type grinder and the particles of epoxy resin are passed through one or more sieves during the grinding process. The mixture of finely divided particles of epoxy resin and finely divided particles of latent curing agent may have a particle size distribution in the range of 0.01 to 1000 μm prior to sintering. In embodiments, the mixture has a particle size distribution prior to sintering in the range of 0.05 to 800 μm, 0.1 to 750 μm, 0.5 to 700 μm, 1 to 650 μm, 2 to 600 μm, 3 to 550 μm, 4 to 500 μm, 5 to 450 μm or 5 to 400 μm, 5 to 350 μm, 5 to 300 μm, 10 to 300 μm, or any combination thereof.

In embodiments, the particle size distribution of the epoxy resin prior to sintering is in the range of about 1 to 1000 μm, 1 to 900 μm, 2 to 850 μm, 3 to 800 μm, 4 to 750 μm, 5 to 700 μm, 6 to 650 μm, 7 to 600 μm, 8 to 550 μm, 9 to 500 μm, 10 to 450 μm, 10 to 400 μm, 10 to 350 μm, 10 to 300 μm, or any combination thereof.

In an embodiment, the Dᵥ90 particle size distribution diameter of the finely divided particles of the epoxy resin prior to sintering is between about 50 to 500 μm, 50 to 300 μm, 50 to 150 μm, 60 to 140 μm, 70 to 130 μm, 80 to 120 μm, 85 to 120 μm, 90 to 120 μm, 95 to 120 μm or any combination thereof.

The latent curing agent may have a particle size distribution in the range of 1 to 100 μm, after grinding or if the latent curing agent is obtained in ready micronized grade from a commercial supplier. In embodiments, the latent curing agent has an average particle size of about 1 to 100 μm, 2 to 90 μm, 3 to 80 μm, 4 to 70 μm, 5 to 60 μm, 6 to 50 μm, 7 to 30 μm, 8 to 20 μm, 5 to 15 μm, 1 to 10 μm or any combination thereof. If present, the flow aid or anti-caking agent may have a similar average particle size to that of the latent curing agent.

The resin composition mixture comprising finely divided particles of epoxy resin and finely divided particles of latent curing agent and optional flow aid is applied to a first layer of fibre reinforcement. The resin composition mixture may be in the form of a powder consisting of particles of very fine size. The manner of application of the resin composition mixture to the fibre reinforcement will generally depend upon the nature of the fibre reinforcement and the scale upon which the method according to the present invention is operated. On a laboratory scale, when the fibre reinforcement layer comprises a layer of woven or non-woven fabric and the resin composition mixture is in the form of a powder, the powder may be distributed over a surface of the layer of fabric as evenly as possible by hand, so as to form a powder layer of the resin composition mixture on top of the fabric reinforcement layer. In an embodiment, a further layer of fibre reinforcement may be applied on top of the layer of resin composition powder. However, the method of manufacturing the prepreg or semipreg precursor according to the present invention is also well-suited to being operated on a larger scale as an industrial process in which some or all of the steps involved may be automated. In this case, the manner of application of the resin composition mixture to the fibre reinforcement layer may be carried out in a number of different ways. For example, the fibre reinforcement layer may comprise a continuous mat of woven or non-woven fabric or continuous supply of unidirectional fibres or filaments that is fed on a conveyor belt or suspended by one or more rollers into a coating area where the resin composition mixture may be applied to an upper surface of the fibre reinforcement layer from a hopper via a screen or sieve or via spraying apparatus or other powder scattering means, or the like. In an embodiment, the continuous supply of fibre reinforcement layer is passed through a chamber in which the amount and surface density of the resin composition mixture being applied to the fibre reinforcement layer can be carefully controlled. If desired, a second layer of fibre reinforcement material may be brought into contact with the resin composition powder coated layer of the first fibre reinforcement layer at a point further downstream in the process and the resultant continuous ply of resin composition mixture powder sandwiched between two fibre reinforcement layers may be fed to a heating area for sintering of the resin composition mixture. However, the methods of applying the resin composition mixture to the fibre reinforcement layer(s) described herein are intended to be illustrative only and it will be apparent that other conventional methodology for such procedures on a manual or automated scale could equally well be employed.

The lamellar structure formed by the first layer of fibre reinforcement, the layer of resin composition mixture and, optionally, the second layer of fibre reinforcement is then subjected to sintering, in order to fuse the resin composition to the fibre reinforcement layer(s). This is typically carried out by heating the structure from ambient temperature to a temperature within or just above the uncured glass transition temperature, Tg, of the epoxy resin(s) and maintaining this temperature for a period sufficient for phase transition to occur. If desired, pressure may also be applied to the lamellar structure at this stage, in order to facilitate the process of compacting or consolidating the epoxy resin into a solid mass without melting and to assist in fusion of the epoxy resin(s) to the fibre reinforcement layer(s). Alternatively, sintering may also be carried out by applying high pressure alone to the epoxy resin, i.e. without the application of heat (other than any heat generated by the application of pressure).

During the sintering step the epoxy resin and latent curing agent form a solid phase in which at least the epoxy resin is a sintered solid. The latent curing agent may also become sintered in this step, but in some embodiments it is not sintered. In either case it forms a discrete phase within the solid epoxy resin.

The sintering conditions for specific resin compositions can be determined in a number of ways. Samples of the resin composition, without fibre reinforcement layers, can be sintered by heating in an electrically heated cell and progress monitored, for example, by DEA and by optical microscopy. For example, the powdered resin composition is deposited on a glass slide and monitored by Dielectric Analysis (DEA) using a Netzsch DEA 288 Ionic Dielectric Analyser manufactured by Netzsch-Geratebau GmbH, Selb, Germany, and by optical microscopy using a Leica DM LM System Microscope manufactured by Leica Microsystems GmbH, Wetzlar, Germany. Typically, the powdered resin composition is heated at a rate of 1° C./min to 45° C. then maintained at this temperature for 60 minutes. In addition, uncured glass transition temperature Tg of the epoxy resin(s) in the resin composition can be measured by Differential Scanning calorimetry (DSC), in accordance with ASTM D3418-15—Standard Test Method for Transition Temperatures and Enthalpies of Fusion and Crystallization of Polymers by Differential Scanning calorimetry, which can be obtained from ASTM International, 100 Barr Harbor Drive, P.O. Box C700, West Conshohocken, Pa., 19428-2959, USA, or ISO 11357-1:2016—Plastics—Differential Scanning calorimetry (DSC)—Part 1—General Principles, which can be obtained from the International Organization for Standardization, ISO Central Secretariat, Chemin de Blandonnet 8, CP 401-1214, Vernier, Geneva, Switzerland. DSC testing can be carried out using any suitable commercially available instruments, including the Q100 Differential Scanning calorimeter manufactured by TA Instruments, New Castle, Del., United States of America, and the Mettler-Toledo DSC 1 manufactured by Mettler-Toledo Ltd., Beaumont Leys, Leicestershire, United Kingdom, in accordance with manufacturer's standard operating procedures.

Sintering of prepreg and semipreg precursors prepared from the resin composition mixture can also be assessed by visual inspection or using sensing technology, as the resin composition mixture, which is typically in the form of an opaque white to off-white powder initially, starts to agglomerate into clumps of opaque material, which can still be physically separated, and then changes to a glass-like phase. Visual inspection reveals particles of undissolved latent curing agent within the glass-like phase. At this stage, the resin composition is fused to the layer or layers of fabric reinforcement and cannot be easily separated. In an embodiment, the layer or layers of fabric reinforcement become partially or substantially impregnated with resin composition after sintering. Complete impregnation of the prepreg or semipreg precursor with the epoxy resin can be achieved by subjecting the prepreg or semipreg precursor to additional heat and/or pressure steps or by laying up the prepreg or semipreg precursor in a mould or its intended final location and curing the precursor directly by the application of heat and/or pressure.

The time and temperature and/or pressure conditions required to sinter the resin composition mixture will depend upon the materials used in the prepreg or semipreg precursor and the scale upon which the method according to the present invention is operated. On a laboratory scale, if the fibre reinforcement layer or layers comprise woven or non-woven fabric and the resin composition mixture is in the form of a powder, for example, sintering may be carried out by heating the lamellar structure up to a temperature of 50° C. for a period of up to 120 minutes. In embodiments of such low-scale manufacture, the lamellar structure is heated to a temperature in the range of 25 to 50° C., 27 to 45° C., 30 to 40° C. or 35 to 40° C., or any combination thereof, for a period of 10 to 120 minutes, 20 to 100 minutes, 30 to 90 minutes, 40 to 80 minutes, 50 to 70 minutes, 50 to 60 minutes, or any combination thereof. Optionally, pressure may also be applied to the lamellar structure in a range of 0.0001 to 1 Bar, 0.0005 to 0.9 Bar, 0.001 to 0.8 Bar, 0.015 to 0.7 Bar, 0.020 to 0.6 Bar, 0.025 to 0.5 Bar, 0.05 to 0.25 Bar, or any combination thereof.

On an industrial scale, if the fibre reinforcement layer or layers and the resin composition mixture are supplied to the process continuously and sintering is carried out by passage through a series of heated rollers, for example, sintering may be carried out by heating the lamellar structure to a temperature of no more than 65° C. In embodiments, sintering is carried out at a temperature in the range of 25 to 65° C., 30 to 60° C., 35 to 55° C., 40 to 50° C., or any combination thereof. Optionally, pressure may also be applied to the lamellar structure during the heating and sintering stage of the production line, for example, by using nip rollers. In such embodiments, the applied pressure is in the range of 0.1 to 5 Bar, 0.2 to 4.5 Bar, 0.3 to 4.0 Bar, 0.4 to 3.5 Bar, 0.5 to 3.0 Bar, 0.6 to 2.5 Bar. 0.7 to 2.0 Bar, 0.8 to 1.5 Bar, 0.9 to 1.0 Bar, or any combination thereof.

In an alternative embodiment, pressure alone may be applied to cause sintering. In such embodiments, high pressures are normally used, for example 20 to 250 Bar, such as 50 to 200 Bar.

Sintering times will vary depending on the conditions used and the materials being sintered. In embodiments, the sintering time will be 1 to 120 minutes, such as 1 to 60 minutes

The prepreg or semipreg precursor produced by sintering the resin composition mixture until fused to the fibre reinforcement layer or layers is then allowed to cool, if necessary, typically to ambient temperature.

The resultant prepreg or semipreg precursor is sufficiently stable at this stage to be stored at ambient temperature, instead of requiring storage in a freezer or under chilled conditions as is generally the case with conventional prepregs.

Prepreg or semipreg precursors prepared in accordance with the second aspect of the present invention can be used individually or assembled into stacks for use in conventional prepreg or semipreg applications, and can be cured by application of heat and, optionally, pressure. Typically, a prepreg or semipreg precursor having a cure temperature of 80° C. may require heating at this temperature for a period of around 360 minutes, whereas a prepreg or semipreg precursor having a cure temperature of 100° C. may require heating at this temperature for a period of around 240 minutes. However, the exact conditions required to achieve 95% cure may be determined empirically using DSC as hereinbefore described. For use in specific applications, test panels prepared by curing prepreg or semipreg precursors may be subjected to interlaminar shear strength (ILSS) testing, in accordance with ISO 14130:1997, which can be obtained from the International Organization for Standardization, ISO Central Secretariat, Chemin de Blandonnet 8, CP 401-1214, Vernier, Geneva, Switzerland, or to cured Tg testing using Dynamic Mechanical Analysis (DMA), in accordance with ASTM D7028-7(2015) (Standard Test Method for Glass Transition Temperature (DMA Tg) of Polymer Matrix Composites by Dynamic Mechanical Analysis (DMA)), which can be obtained from ASTM International, 100 Barr Harbor Drive, PO Box C700, West Conshohocken, Pa., 19428-2959, USA, or ISO 6721-11:2012—Plastics—Determination of Mechanical Properties—Part 11—Glass Transition Temperature, which can be obtained from the International Organization for Standardization, ISO Central Secretariat, Chemin de Blandonnet 8, CP 401-1214, Vernier, Geneva, Switzerland,

We have found that the prepreg or semipreg precursors produced by the method according to the present invention are easy to handle because there is no powder hazard associated with the resin composition after sintering and, unlike many conventional prepregs, the resin composition is in a solid glass-like state rather than a viscous mobile phase. Moreover, the prepreg or semipreg precursors can be cured at temperatures below 100° C. but still show outlife of at least 6 months at temperatures up to 35° C., at least 2 months at temperatures up to 45° C. and up to 3 weeks at 55° C.

In an embodiment, in which the fibre reinforcement layer or layers consist of two or more plies of woven or non-woven fabric or unidirectional tows or fibres that have not been attached to one another, the resin composition fused to the fibre reinforcement layers during sintering acts as attachment means to hold the different fibre orientations together in the fibre layers until the prepreg or semipreg precursors are cured. The plies of woven or non-woven fabric or unidirectional tows or fibres may be stitch-free. This may be beneficial when the method according to the present invention is operated on an industrial scale in which the fibre reinforcement layer(s) would otherwise be stitched together before being incorporated into a prepreg,

In another embodiment, the method according to the second aspect of the present invention further comprises a step of applying a tack layer to at least one surface of the prepreg or semipreg precursor during or after its formation. Such a tack layer may prove useful for laying up the prepreg or semipreg precursors in a mould in certain applications. Any suitable materials can be used for the tack layer, including but not limited to epoxy resins, especially semi-solid or liquid epoxy resins.

In the prepreg and semipreg precursors of the present invention, the resin composition is stably attached to the fibre reinforcement layer or layers, such that the fibre layer or layers cannot easily be separated from the resin composition mixture. The solid latent curing agent may be mainly or completely isolated within the solid epoxy resin thereby hindering potential interaction with external sources, such as air or trace contaminants. The latent curing agent remains in this state until the prepreg or semipreg precursor is heated to its curing temperature when the epoxy resin melts, dissolving the latent curing agent and initiating cure.

Cured materials formed from the prepreg and semipreg precursors of the present invention have been found to have significantly lower levels of porosity than materials produced from commercially available prepregs and semipregs.

When prepreg and semipreg precursors of the present invention are cured the exotherm temperature has been found to be much lower than for commercially available prepregs and semipregs. This means that the prepreg and semipreg precursors of the invention have the potential to be cured at higher temperatures and/or faster ramp rates than the commercial materials, leading to reduced cure times and therefore cost and/or time savings.

In a further aspect of the present invention, there is provided the use of a prepreg or semipreg precursor according to certain aspects of the present invention in the manufacture of wind turbine components.

### EXAMPLES

Resin Composition 1a

A powdered epoxy resin blend was prepared from 87 g Araldite® GT6071 (a solid Bisphenol A diglycidyl ether epoxy resin manufactured by Huntsman Advanced Materials (Switzerland) GmbH, Basel, Switzerland) and 9.7 g Araldite® LY1589 (a semi-solid Bisphenol A diglycidyl ether epoxy resin manufactured by Huntsman Advanced Materials (Switzerland) GmbH, Basel, Switzerland). The epoxy resins were heated to 80° C. before being thoroughly mixed and the resultant blend allowed to cool to ambient temperature. The solidified resin blend was broken into small pieces and ground with dry ice on a Retsch® Ultra Centrifugal Mill ZM200 manufactured by Retsch GmbH, Haan, Germany. The resin blend was ground twice, once through a 1 mm sieve then followed by a 250 μm sieve. Particle size distribution was measured using a Horiba LA-950 Laser Particle Size Analyser Version 2 manufactured by Horiba, Ltd., Kyoto, Japan. Particle size analysis of the powdered epoxy resin blend gave a typical D(v, 0.9) value of 131 μm.

3 g Dyhard® UR500 (a difunctional latent urone accelerator in powder form, having a melting point specification of 180° C. and a particle size 98% specification of less than 10 μm, manufactured by AlzChem Group AG, Trostberg, Germany) and 0.3 g Aerosil® R202 (a hydrophobic fumed silica anti-caking agent manufactured by Evonik Resource Efficiency GmbH, Hanau-Wolfgang, Germany) were thoroughly mixed into the powdered epoxy resin blend in a flask by hand, using a tumbling and shaking motion, to provide resin composition 1a.

Resin Composition 1b

Resin composition 1 b was prepared in an analogous manner to resin composition 1a, but using a larger batch of a commercially ground epoxy resin blend of Araldite® GT6071 and Araldite® LY1589 in the same weight ratio as in resin composition 1a. Particle size distribution was measured using a Horiba LA-950 Laser Particle Size Analyser Version 2 manufactured by Horiba, Ltd., Kyoto, Japan. Particle size analysis of the commercially ground powdered epoxy resin blend gave a typical median size value of 45.5 μm, a typical mean size value of 48.1 μm, a typical D(v, 01.) value of 20.8 μm, a typical D(v, 0.2) value of 45.5 μm and a typical D(v, 0.9) value of 94.1 μm.

The epoxy resin blend was mixed with Dyhard® UR500 and Aerosil® R202 in the same weight ratio as in resin composition 1a using an industrial blender, to provide resin composition 1 b.

Resin Composition 2

A powdered epoxy resin was prepared from 96.4 g Araldite® GT7071 (a solid Bisphenol A diglycidyl ether epoxy resin manufactured by Huntsman Advanced Materials (Switzerland) GmbH, Basel, Switzerland) by grinding small pieces of the resin with dry ice on a Retsch® Ultra Centrifugal Mill ZM200 manufactured by Retsch GmbH, Haan, Germany. The resin blend was ground twice, once through a 1 mm sieve then followed by a 250 μm sieve. Particle size distribution was measured using a Horiba LA-950 Laser Particle Size Analyser Version 2 manufactured by Horiba, Ltd., Kyoto, Japan. Particle size analysis of the powdered epoxy resin blend gave a typical D(v, 0.9) value of 126 μm.

3.3 g Omicure® U52M (a difunctional latent urone accelerator in micronized form, having a melting point specification of 220 to 230° C. and a particle size specification of a minimum of 80% through a 325 mesh screen, manufactured by Emerald Performance Materials, Moorefield, N.J., USA) and 0.3 g Aerosil® R202 (a hydrophobic fumed silica anti-caking agent manufactured by Evonik Resource Efficiency GmbH, Hanau-Wolfgang, Germany) were thoroughly mixed into the powdered epoxy resin blend by hand, using a tumbling and shaking motion, to provide resin composition 2.

### Preparation of Preforms and Test Panels

Powder resin composition 1a or powder resin composition 2 was spread evenly at a loading of 1200 g/m² over a first 150 mm×150 mm ply of BB1200 fabric (1200 g/m² biaxial glass fabric with the tows at ±80° with stitching in the unidirectional (UD) direction manufactured by Hexcel Reinforcements UK Limited, Narborough, Leicestershire, United Kingdom) enclosed within a cork barrier to contain the powder. A second 150 mm×150 mm ply of BB1200 fabric was placed on top of the resin powder layer to provide a preform.

Individual preforms were sintered in the manner described below and used immediately or subjected to further aging at 35° C. or 45° C. before curing and testing. Test panels were prepared from stacks of two individual preforms which were cured in the manner described below and used for measurement of cured glass transition temperature, Tg, by Dynamic Mechanical Analysis (DMA) and for measurement of Interlaminar Sheer Strength (ILSS).

Sintering of Resin Compositions and Preforms

Samples of powdered resin composition 1 b or resin composition 2, without any layers of fibre reinforcement, were sintered for test purposes in an electrically heated cell. The resin was deposited on a glass slide and monitored by Dielectric Analysis (DEA) using a Netzsch DEA 288 Ionic Dielectric Analyser manufactured by Netzsch-Gerätebau GmbH, Selb, Germany, and by optical microscopy using a Leica DM LM System Microscope manufactured by Leica Microsystems GmbH, Wetzlar, Germany. The powdered resin composition was heated at a rate of 1° C./min to 45° C. then maintained at this temperature for 60 minutes. During sintering, particles of resin composition agglomerated and then changed appearance from an opaque white powder to a glass like-state.

Samples of sintered resin composition were used immediately or aged at 35° C. for periodic measurements of uncured glass transition temperature Tg by Differential Scanning calorimetry as an indication of outlife. Uncured glass transition temperature of the resin compositions was measured by Differential Scanning calorimetry (DSC), in accordance with ASTM 3418-15 or ISO 11357-1:2016, using a Q100 Differential Scanning calorimeter manufactured by TA Instruments, New Castle, Del., United States of America, or a Mettler-Toledo DSC 1 manufactured by Mettler-Toledo Ltd., Beaumont Leys, Leicestershire, United Kingdom, in accordance with the manufacturer's standard operating procedures.

Individual preforms were sintered by heating at 45° C. for 60 minutes. During sintering, particles of resin composition agglomerated and then changed appearance from an opaque white powder to a glass like-state which impregnated adjacent fabric layers. After sintering was complete, the preforms were allowed to cool to ambient temperature, when the fabric layers were found to be firmly fused to one another and to the resin composition.

Curing of Test Panels, ILSS and cured Tg Measurements

Test panels were cured by heating stacks of two individual preforms to a temperature of 80° for 360 minutes (resin composition 1a) or to 100° C. for 240 minutes (resin composition 2). Cured test panels were allowed to cool to ambient temperature before measurement of ILSS and cured Tg.

Interlaminar Shear Strength (ILSS) was tested according to ISO 14130:1997 using a ZwickRoell Z010 10 kN with a flexural or crossover jig manufactured by ZwickRoell GmbH & Co. KG, Ulm Germany. Specimens were made with a Tyro Saw manufactured by Prosaw Limited, Kettering, Northamptonshire, United Kingdom. ILSS measurements were taken on test panels formed by curing stacks of two preforms immediately after sintering and after aging at 35° C.

Cured glass transition temperature of test panels was measured by Dynamic Mechanical Analysis (DMA) using a TA Q800 DMA Instrument manufactured by TA Instruments, New Castle, Del., USA, in accordance with ASTM D7028-7(2015).

Results

DSC measurements for resin composition 1 b aged at 35° C. showed an initial uncured onset Tg of 23° C. at day 0, which increased to 25° C. at day 8 and then remained stable between 25° C. and 29° C. up to day 170.

DSC measurements for resin composition 2 aged at 45° C. showed an initial uncured onset Tg of 35° C. at day 0, which remained stable between 35° C. and 40° C. up to day 405.

In comparison, DSC measurements for a commercially available epoxy resin matrix composition (a resin matrix comprising a difunctional Bisphenol A based liquid epoxy resin and a urone curative) aged at 35° C. showed that uncured onset Tg increased exponentially from an initial value of 4° C. on day 0 to a value of 42° C. at day 25. Such an increase indicates that the resin matrix has aged to such an extent that curing will produce a component part with inferior mechanical properties, which can be confirmed by ILSS tests.

ILSS test results on cured test panels prepared from preforms comprising resin composition 1a aged at 35° C. showed an initial interlaminar shear strength value of 70 MPa at day 0 and a retained value of 57 MPa at day 84.

ILSS test results on cured test panels prepared from preforms comprising resin composition 2 aged at 45° C. showed an initial interlaminar shear strength value of 60 MPa at day 0 and a retained value of 49 MPa at day 84.

In comparison, test panels prepared from prepregs comprising a standard resin matrix, such as the above commercial resin, are predicted to have a typical retained interlaminar shear strength of no more than 30 MPa after aging at 35° C. for up to 12 weeks or less, on the basis of evolution of uncured Tg at 35° by DSC analysis of such resin matrices.

Prepreg or semipreg precursors prepared from resin composition 2 had a calculated outlife of 12 weeks at 45° C.

1. A prepreg comprising a fibre reinforcement and a resin composition fused thereto, the resin composition containing at least one epoxy resin and a latent curing agent, wherein the epoxy resin and the latent curing agent form a solid phase at ambient temperature, the latent curing agent forming a discrete phase within the epoxy resin.

2. The prepreg of claim 1, wherein the resin composition is free of amine or latent amine components.

3. The prepreg of claim 2, wherein the latent curing agent is a substituted urea.

4. The prepreg of claim 3, wherein the resin composition is distributed on a surface of the fibre reinforcement.

5. (canceled)

6. (canceled)

7. (canceled)

8. The prepreg of claim 4, wherein the epoxy resin component of the resin composition comprises one or more epoxy resins that are all solid at ambient temperature prior to formation of the resin composition.

9. (canceled)

10. (canceled)

11. (canceled)

12. (canceled)

13. The prepreg of claim 8, wherein the fabric is a multiaxial non-woven or non-crimped fabric.

14. (canceled)

15. (canceled)

16. A method of manufacturing a prepreg, which comprises the steps of:
(a) preparing a resin composition mixture containing finely divided particles of at least one epoxy resin and finely divided particles of a latent curing agent, wherein the epoxy resin and the latent curing agent are both in the solid phase at ambient temperature;
(b) applying a layer of the resin composition mixture to a first layer of fibre reinforcement;
(c) sintering the lamellar structure of step (b) so as to fuse the resin composition to the fibre reinforcement layer and so that the latent curing agent font's a discrete phase within the sintered epoxy.

17. The method of manufacturing a prepreg of claim 16, wherein the resin composition is free of amine or latent amine components.

18. (canceled)

19. The method of manufacturing a prepreg of claim 17, wherein the latent curing agent does not undergo sintering in step (c).

20. The method of manufacturing a prepreg of claim 19, wherein the epoxy resin component of the resin composition comprises one or more epoxy resins that are all solid at ambient temperature prior to formation of the resin composition, such that the mixture is a solid at ambient temperature.

21. (canceled)

22. (canceled)

23. The method of manufacturing a prepreg of claim 20, wherein the sintering in step (c) is carried out by applying heat and/or pressure to the resin composition when it is in contact with the layer of fibre reinforcement.

24. The method of manufacturing a prepreg of claim 23, wherein the sintering in step (c) is carried out at a temperature within or just above the glass transition temperature of the uncured epoxy resin.

25. The method of manufacturing a prepreg of claim 24, Wherein the sintering in step (c) is carried out at a temperature of in the range of 35° C. to 55° C.

26. The method of manufacturing a prepreg of claim 25, further comprising applying pressure to the lamellar structure of step (c) during sintering, in a range of 0.5 to 3 Bar.

27. (canceled)

28. The method of manufacturing a prepreg of claim 26, wherein sintering in step (c) is carried out for a period of 1 minute to 60 minutes.

29. The method of manufacturing a prepreg of claim 28, wherein the particle size distribution of the mixture of finely divided particles of the epoxy resin and finely divided particles of the latent curing agent is between about 5 to 400 μm prior to sintering.

30. The method of manufacturing a prepreg of claim 29, wherein the particle size distribution of the finely divided particles of the epoxy resin is between about 10 to 500 μm prior to sintering; and wherein the Dᵥ90 particle size distribution diameter of the finely divided particles of the epoxy resin prior to sintering is between about 50 to 150 μm.

31. (canceled)

32. (canceled)

33. (canceled)

34. The method of manufacturing a prepreg of claim 30, wherein the fabric is a multiaxial non-woven or non-crimped fabric.

35. (canceled)

36. (canceled)

37. (canceled)
